(19) United States
(12) Patent Application Publication
(10) Pub. No.: US 2015/0010893 A1
(43) Pub. Date: Jan. 8, 2015

(54) LEARNING CURVE DISAGGREGATION BY STUDENT MASTERY

(71) Applicant: Apollo Education Group, Inc., Phoenix, AZ (US)

(72) Inventors: Steven Ritter, Phoenix, AZ (US); Tristan Nixon, Pittsburgh, PA (US); Robert Murray, Pittsburgh, PA (US); Ryan Schwiebert, Phoenix, AZ (US); Stephen Fancsali, Pittsburgh, PA (US)

(21) Appl. No.: 14/326,327

(22) Filed: Jul. 8, 2014

Related U.S. Application Data
(60) Provisional application No. 61/843,832, filed on Jul. 8, 2013.

(51) Int. Cl. G09B 7/08

(52) U.S. Cl. CPC G09B 7/08
USPC 434/350

(57) ABSTRACT

Techniques are described for disaggregating learning curves by student mastery for refining and accurately evaluating automated tutoring models. A method comprises receiving performance data for users logging whether a correct response was provided for each opportunity to use a particular skill in a tutoring system, determining a plurality of subpopulations from the users by using the performance data to group by number of opportunities needed for the particular skill to reach a mastery threshold, creating disaggregated learning curves for each of the plurality of subpopulations that map performance opportunities to percentages correct, and evaluating the disaggregated learning curves to identify a suitable adaptation for the tutoring system. The suitable adaptation may then be carried out and may include sending a notification of portions of the tutoring system that need attention and/or adjusting parameters of the tutoring system for a projected learning progression of a particular user.

### CROSS-REFERENCE TO RELATED APPLICATIONS; BENEFIT CLAIM

This application claims the benefit of U.S. Provisional Application No. 61/843,832, filed Jul. 8, 2013, which is hereby incorporated by reference in its entirety for all purposes as if fully set forth herein.

### FIELD OF THE INVENTION

The present invention relates to algorithms for automated tutoring, and more specifically, to disaggregating learning curves by student mastery for refining and accurately evaluating automated tutoring models.

### BACKGROUND

Learning curves that depict student performance over time are used to evaluate whether students are learning. Learning curves use data that is aggregated across multiple students in order to average out the effects of irrelevant factors and thereby better detect the underlying trajectory of learning as a function of practice.

Mastery learning, on the other hand, is used with individual students to provide them with just enough practice so that they master the material without practicing more than necessary. For example, on the assumption that knowledge can be decomposed into discrete knowledge components, referred to herein as “skills”, a skill profile can be generated for each student, using algorithms such as Bayesian Knowledge Tracing (BKT). Based on the skill profiles, mastery learning can be applied to tailor the lessons for each student such that all students master the material with the minimum amount of practice suitable for each student.

When a learning curve is generated from the mastery learning of multiple students, the aggregated result may inaccurately reflect the learning that is actually occurring for each student. Since learning curves are frequently used to evaluate the effectiveness of automated tutoring models, an inaccurate learning curve can result in a faulty evaluation of software implementing an automated tutoring model. This faulty evaluation may prevent development resources from being directed to the areas of the automated tutoring model that need the most attention, resulting in less than optimal tutoring for students. If the inaccurate learning curves are used with other internal or external data, misleading results may be provided.

Further, the learning curves may be also used within the software itself, for example by matching a student skill profile to a known or projected learning curve for a particular skill. The various parameters of the automated tutoring model can then be refined and adapted to match the learning curve, which can then affect problem difficulty, lesson speed, skill development priorities, and other settings. However, if the learning curve does not accurately reflect true student learning progressions, then the adjustment of the parameters will similarly be inaccurate.

Based on the foregoing, there is a need for a method to accurately refine and evaluate automated tutoring models, particularly those that utilize mastery learning.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example network arrangement for a tutoring system that adapts by evaluating disaggregated learning curves by student mastery, according to embodiments.

FIG. 2 depicts an aggregate learning curve that approximates a power function.

FIG. 3 depicts a standard aggregate learning curve that shows little student learning.

FIG. 4A depicts learning curves disaggregated according to an embodiment by the number of opportunities that it takes each subpopulation to reach skill mastery, aligned by opportunity number.

FIG. 4B depicts learning curves disaggregated according to an embodiment by the number of opportunities that it takes each subpopulation to reach skill mastery, aligned by the opportunity at which each subpopulation first achieves mastery.

FIG. 5 depicts a flowchart for a tutoring system that adapts by evaluating disaggregated learning curves by student mastery, according to an embodiment.

FIG. 6 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Learning curves aggregated across all students frequently underestimate the learning that is occurring, not just at the tail of the curve but throughout most of its length. Furthermore, this is particularly the case for students engaged in mastery learning. For example, a learning curve may show the percentage of correct answers from multiple students as a function of the number of opportunities, or the number of attempted questions. As the learning curve progresses to a larger number of opportunities, the learning curve must be averaged using only those students that are still attempting additional questions, as systems implementing mastery learning stop providing additional questions to those students who have already attained mastery. Accordingly, the learning curve is negatively impacted by the unavailability of data from students who have already attained mastery.

By using learning curves that are disaggregated by student mastery, or number of opportunities needed to reach skill mastery, several problems can be overcome. First, learning can be detected from aggregated learning curves that appear to show little to no learning, correcting the negative effects of mastery learning on aggregate learning curves. Second, the different subsets of students that are learning and not learning, if any, can be identified, and the characteristics of each subset can be analyzed, such as initial knowledge or skill levels and the rates of mastery. Accordingly, the disaggregated learning curves can provide a more accurate evaluation of a particular automated tutoring model, and the disaggregated learning curves can also be used to more effectively refine the parameters of the automated tutoring model to adapt to each student.

### Tutoring System Architecture

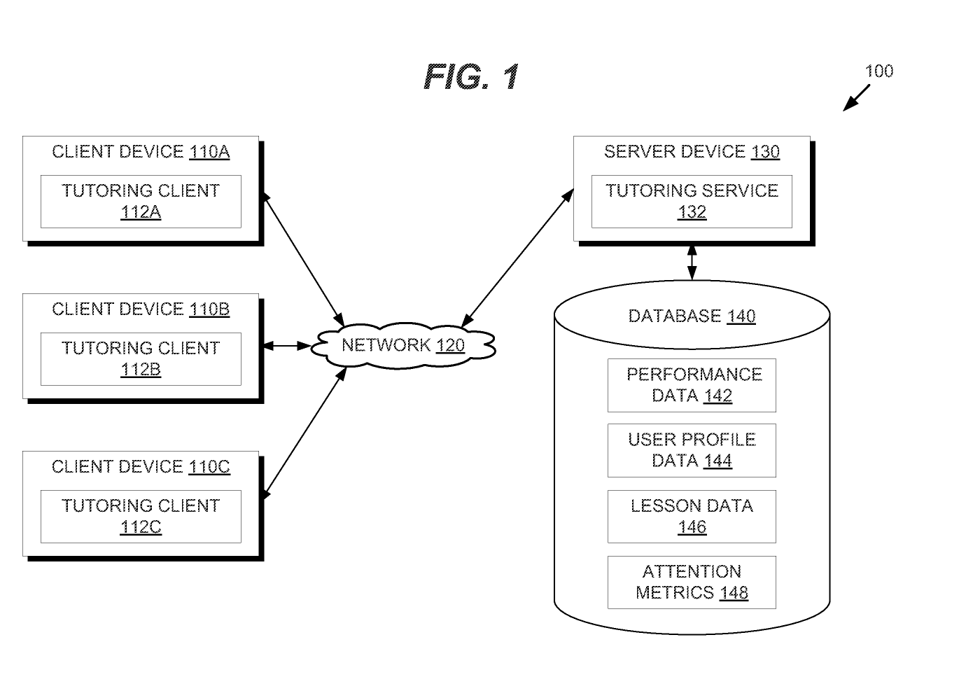

Before discussing the specifics of the disaggregated learning curves, it may be helpful to provide a system architecture overview of an example tutoring system for which the disaggregated learning curves can be used. FIG. 1 is a block diagram that depicts an example network arrangement 100 for a tutoring system that adapts by evaluating disaggregated learning curves by student mastery, according to embodiments. Network arrangement 100 includes client device 110A, client device 110B, client device 110C, network 120, server device 130, and database 140. Client device 110A includes tutoring client 112A, client device 110B includes tutoring client 112B, and client device 110C includes tutoring client 112C. Server device 130 includes tutoring service 132. Client devices 110A-110C and server device 130 are communicatively coupled by network 120. Server device 130 is also communicatively coupled to database 140. Database 140 includes performance data 142, user profile data 144, lesson data 146, and attention metrics 148. Network arrangement 100 may include other devices, including additional client devices, server devices, and display devices, according to embodiments.

Client devices 110A-110C may be implemented by any type of computing device that is communicatively connected to network 120. Example implementations of client device 110A-110C include, without limitation, workstations, personal computers, laptop computers, personal digital assistants (PDAs), tablet computers, cellular telephony devices such as smart phones, and any other type of computing device.

In network arrangement 100, client devices 110A-110C are configured with respective tutoring clients 112A-112C that may access tutoring service 132. Tutoring clients 112A-112C may be implemented in any number of ways, including as a plug-in to a web browser, as an application running in connection with web page provided by tutoring service 132, as a stand-alone native binary application, or by other means. Client devices 110A-110C may be configured with other mechanisms, processes and functionalities, depending upon a particular implementation.

Further, client devices 110A-110C are each communicatively coupled to a display device (not shown in FIG. 1) for displaying graphical user interfaces. Such a display device may be implemented by any type of device capable of displaying a graphical user interface. Example implementations of a display device include a monitor, a screen, a touch screen, a projector, a light display, a display of a tablet computer, a display of a telephony device, a television, etc.

Network 120 may be implemented with any type of medium and/or mechanism that facilitates the exchange of information between client devices 110A-110C and server device 130. Furthermore, network 120 may facilitate use of any type of communications protocol, and may be secured or unsecured, depending upon the requirements of a particular embodiment.

Server device 130 may be implemented by any type of computing device that is capable of communicating with client devices 110A-110C over network 120. In network arrangement 100, server device 130 is configured with a tutoring service 132, which may be part of a cloud computing service. Functionality attributed to tutoring service 132 may also be performed by tutoring clients 112A-112C, according to embodiments. Server device 130 may be configured with other mechanisms, processes and functionalities, depending upon a particular implementation.

Server device 130 is communicatively coupled to database 140. As shown in FIG. 1, database 140 includes various data elements that can be used to tailor tutoring service 132 for the individual needs of each user at respective client devices 110A-110C, as discussed in further detail below. Database 140 may reside in any type of storage, including volatile and non-volatile storage (e.g., random access memory (RAM), one or more hard or floppy disks, main memory, etc.), and may be implemented by multiple logical databases. The storage on which database 140 resides may be external or internal to server device 130.

Any of tutoring clients 112A-112C and tutoring service 132 may receive and respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication, e.g., from one of the other tutoring clients 112A-112C or tutoring service 132. Further, any of tutoring clients 112A-112C and tutoring service 132 may send one or more of the following over network 120 to one of the other entities: information via HTTP, HTTPS, SMTP, etc.; XML data; SOAP messages; API calls; and other communications according to embodiments.

In an embodiment, each of the processes described in connection with one or more of tutoring clients 112A-112C and tutoring service 132 are performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### Intelligent Tutoring System

According to an embodiment, tutoring clients 112A-112C and/or tutoring service 132 are implemented as part of an intelligent tutoring system, such as the cognitive tutor described in Koedinger, K. R., Anderson, J. R., Hadley, W. H., & Mark, M. A. (1997), Intelligent tutoring goes to school in the big city, International Journal of Artificial Intelligence in Education, 8, 30-43, and Anderson, J. R., Corbett, A. T., Koedinger, K. R., & Pelletier, R. (1995), Cognitive Tutors: Lessons Learned, The Journal of the Learning Sciences, 4(2), 167-207, both of which are incorporated herein by reference.

Creating Learning Curves that are Disaggregated by Student Mastery

As discussed above, when compared to aggregated learning curves, disaggregated learning curves can provide a more accurate evaluation of a particular automated tutoring model to better target limited development resources and to better adapt lessons for individual users. Thus, in addition to disaggregating learning curves by knowledge component or skill, learning curves are also disaggregated by number of opportunities until mastery. Below, the specifics of disaggregating learning curves are described with an implementation for the educational software application, Cognitive Tutor, an intelligent automated tutoring system as discussed above. The fundamental assumption behind Cognitive Tutors is that knowledge can be decomposed into discrete knowledge components—i.e., skills—and that learning is best modeled through these skills. These skills act as components in a cognitive model of the student. If the skills that students are actually learning are correctly identified, improvement in performance (e.g., reduced errors) should result as students gain more experience with those skills. To the extent that the modeled skills are not aligned with what students are learning, learning on those skills may not result.

These skill-based cognitive models are used in two ways. First, within a tutor at runtime, the cognitive model is used as the basis for Bayesian Knowledge Tracing (BKT) to assess whether individual students have mastered the material. Second, learning curves, aggregated across students, are used to test whether the modeled skills correspond to the skills that students are learning. If students are not learning a skill, then resources should be directed towards a corresponding improvement to the software.

In one embodiment, Cognitive Tutors use Corbett and Anderson's Bayesian Knowledge Tracing (BKT) algorithm at runtime to estimate the probability that each skill is known, or p_known. In an embodiment, the Cognitive Tutors may calculate p_known as an estimated probability of whether a particular skill is in a “known” state for a user, with larger numbers indicating a greater probability of being in the “known” state rather than an “unknown” state. The BKT algorithm uses four parameters to estimate p_known for each skill: p_initial, the probability that a student knows the skill prior to using it in the tutor; p_learn, the probability that the skill will transition from unknown to known following usage in the tutor; p_guess, the probability of correct performance when the skill is unknown; and p_slip, the probability of incorrect performance when the skill is known. Cognitive Tutor problems typically require multiple steps to solve, and each of these steps is normally associated with at least one skill, so problems usually include multiple skills. In addition, Cognitive Tutor includes multiple problems with any particular skill so that students can have multiple opportunities to master a skill without repeating problems. Mastery learning is implemented by requiring students to solve problems until p_known for each skill in the section has reached 0.95. See Anderson, J. R., Conrad, F. G., & Corbett, A. T. (1989), Skill acquisition and the LISP tutor in Cognitive Science, 14(4), 467-505 and Corbett, A. T., & Anderson, J. R. (1995), Knowledge tracing: Modeling the acquisition of procedural knowledge in User-Modeling and User-Adapted Interaction, 4, 253-278, both of which are incorporated herein by reference.

As students use a Cognitive Tutor, data about their performance is logged. Of particular interest here is logging the success of each opportunity to use a skill as either correct or incorrect, where incorrect includes both errors and student requests for help with a step associated with the skill. The usual way to create a learning curve for a skill is to graph the percentage of all students whose performance was correct for each opportunity to use a skill (across problems). Thus, each problem may present the opportunity to exercise multiple different skills, and performance data is logged for each skill.

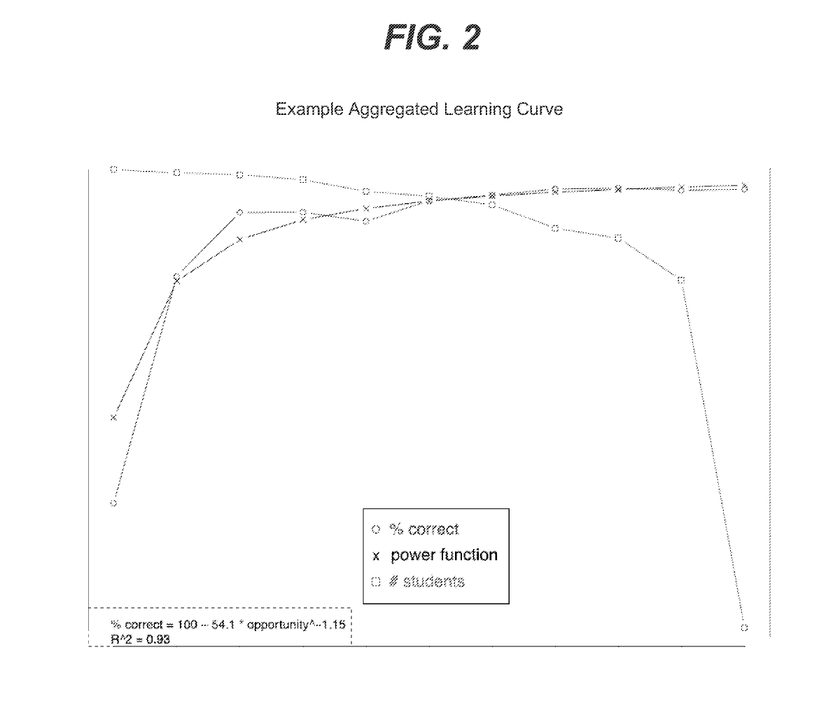

FIG. 2 depicts an aggregate learning curve that approximates a power function. More specifically, the learning curve corresponds to the skill “Write absolute value equation” in an example Cognitive Tutor Algebra I curriculum. This skill corresponds to the knowledge required to answer a prompt like “Enter an absolute value equation to represent all points that are 5 units from zero on the number line” with the answer “|x|=5.” The x-axis represents opportunities, or encounters with the skill. The left-hand y-axis shows the percentage of students who were correct at each opportunity, and the right-hand y-axis shows the number of students contributing to the data. FIG. 2 shows that students averaged 27% correct on their first encounter with this skill, and that performance rapidly increased to approximately 90% correct by the third encounter. The number of students drops off as BKT determines that students have mastered the skill. Thus, the right-hand side of the aggregate learning curve is dominated by students who require a relatively large number of opportunities to master the skill.

A ubiquitous finding for a wide variety of cognitive tasks, as well as perceptual motor tasks and other phenomena, is that performance appears to follow the power law of practice: performance improves rapidly at first and continues to improve but at a diminishing rate in a power function, where performance is a function of some power of the amount of practice (e.g., the number of opportunities): E=E₀*n^{-α}, where E=error rate, E₀ (the intercept) is initial error rate, n is the opportunity number, and the exponent a controls the rate of change, equivalent to the linear slope when the data is plotted on log-log axes. See Newell, A., & Rosenbloom, P. S. (1981), Mechanisms of skill acquisition and the law of practice in J. R. Anderson (Ed.), Cognitive Skills and Their Acquisition (pp. 1-55). Hillsdale, N.J.: Lawrence Erlbaum Associates, which is incorporated herein by reference.

For learning curves in Cognitive Tutor, the error rate is transformed into percentage correct as C=100−E=100−E₀*n^{-α}. The fitted power function for the skill in FIG. 2 is C=100−54.1*n^{-1.15} with fit R²=0.93. The α (exponent) value of −1.15 indicates good learning, with percentage correct improving rapidly at first and then approaching an asymptote of 100%. Given these considerations, it might seem reasonable that a learning curve that more closely approximates a power function would be more likely to accurately represent student learning. Similarly, a learning curve that does not fit a power function well, or that fits with very small α (indicating little improvement over time) would indicate that students are not improving on actions labeled with that skill.

However, aggregate learning curves are not always a reliable guide to whether skills accurately model student learning. When averaging over different students who begin with different levels of knowledge and/or learn at different rates, aggregate learning curves may appear to show little student learning even though BKT identifies the students as mastering the skills at runtime.

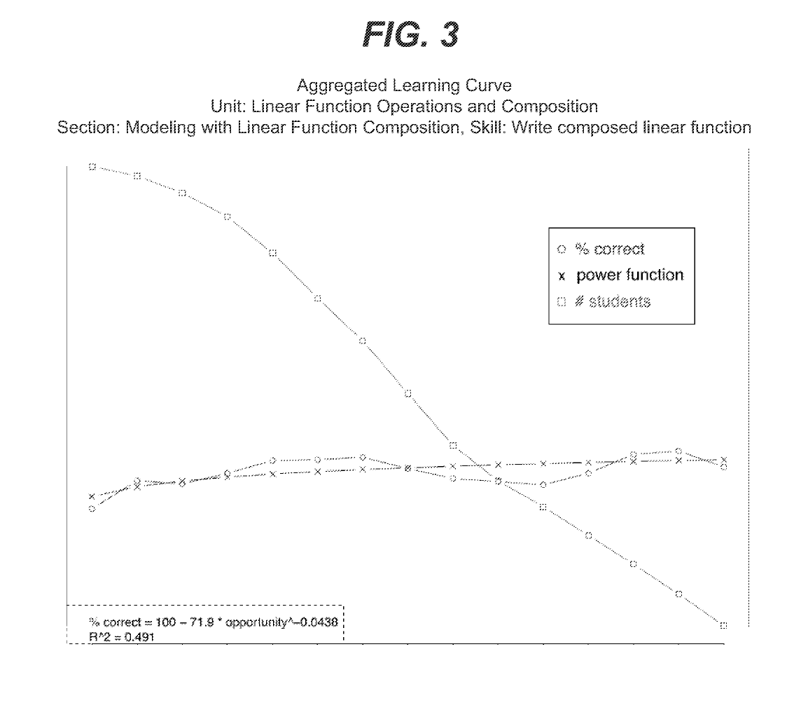

FIG. 3 depicts a standard aggregate learning curve that shows little student learning. The skill for this learning curve is from an example Cognitive Tutor Algebra II curriculum and corresponds to the knowledge required to write a composed linear function such as “1.6(19 g)” to represent the number of kilometers a driver can go on g gallons of gas in a car that gets 19 miles/gallon, using a conversion factor of 1.6 kilometers/mile. For this skill, students initially average about 26% correct and, after 15 opportunities, they still average just a little over 30% correct. The fitted power function's α value −0.0438 makes a relatively flat learning curve, which seems to indicate poor learning. However, the fact that the number of students drops off fairly quickly (from 1100 students at opportunity 1, to 300 students at opportunity 15) indicates that, at runtime, the tutor (using BKT) considered most students to have mastered this skill.

To resolve the discrepancy between runtime assessments of mastery and the poor learning results shown in some aggregate learning curves, the student performance data was disaggregated for each skill by the number of attempts it took students to reach mastery. For instance, the performance data for the skill “Write composed linear function” whose learning curve is shown in FIG. 3 was disaggregated into sets of subsets of the data for students who required 3 opportunities to reach mastery, 4 opportunities to reach mastery, and so on until 15 or more opportunities to reach mastery. Then separate, disaggregated learning curves were created for each number of attempts it took to reach mastery for each skill.

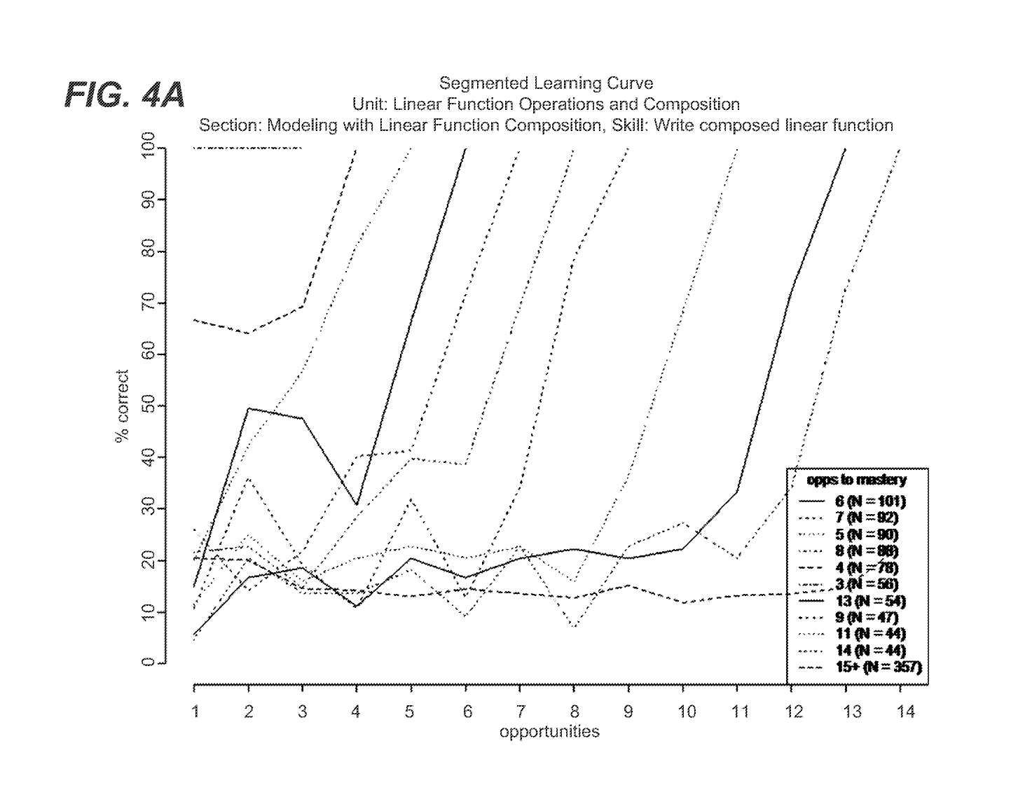

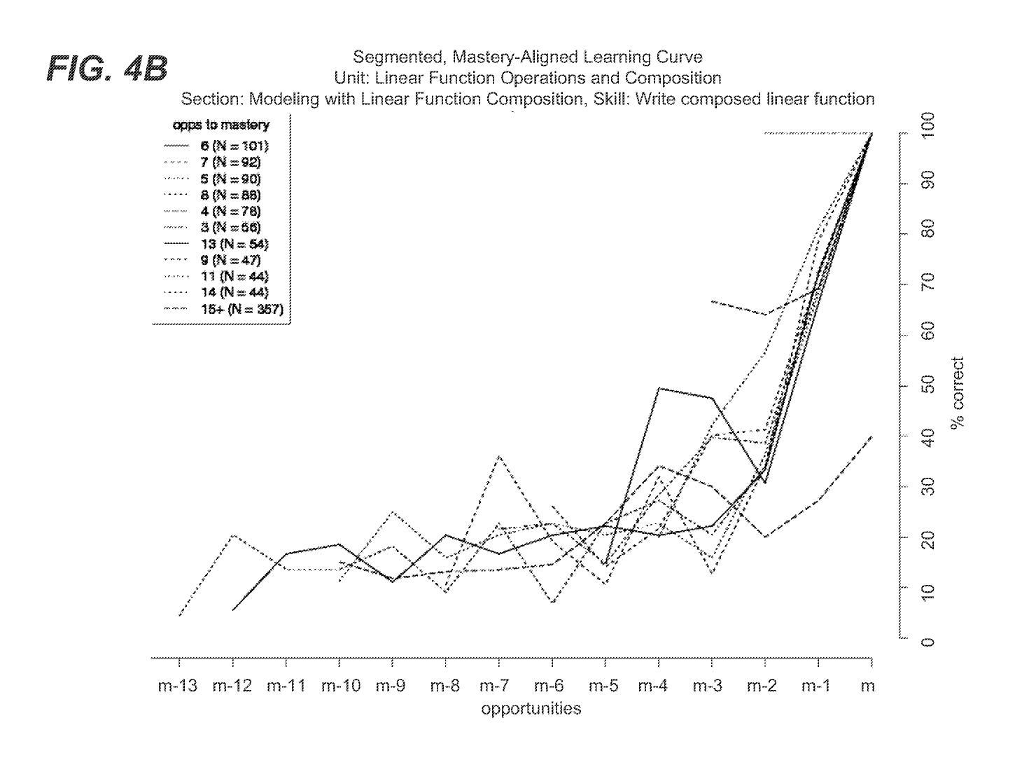

FIG. 4A depicts learning curves disaggregated according to an embodiment by the number of opportunities that it takes each subpopulation to reach skill mastery (p_known=0.95), aligned by opportunity number. The disaggregated learning curves shown in FIG. 4A use the same performance data that was used in FIG. 3, and also concern the same skill of writing a composed linear function. Thus, each learning curve in FIG. 4A represents a subpopulation of students who were judged by the tutor at runtime to have mastered the skill in the same number of opportunities, except for the bottom right curve, which represents students who took 15 or more opportunities to reach mastery. The number of opportunities shown for each curve is limited to those required to reach mastery because learning curves degrade as the number of students decreases. Thus, even if performance data points are available for opportunities after mastery, those performance data points may be omitted from the learning curve. These curves are somewhat noisier than the single aggregate curve due to the lower number of data points represented by each curve. See Martin, B., Mitrovic, A., Koedinger, K. R., & Mathan, S. (2011), Evaluating and improving adaptive educational systems with learning curves in User Modeling and User-Adapted Interaction, 21, 249-283, which is incorporated herein by reference.

Each of the disaggregated learning curves in FIG. 4A does appear to show learning except for the curve for students who needed 15 or more opportunities (some of whom may never reach mastery), which is cut off. The curve at the upper left shows that the only way to reach mastery in 3 opportunities is by perfect performance, since the “curve” is actually a flat line. The curves for students who needed 3 and 4 opportunities to reach mastery reflect higher probabilities that the students know the skill initially (before they use it in the tutor), corresponding to higher values for p_initial in the BKT knowledge tracing algorithm. The other curves show similar probabilities for initial knowledge but show different probabilities of learning the skill as they encounter opportunities to use it, which may correspond to different values for the BKT parameter p_learn.

As discussed above, one effect on the aggregate learning curve due to mastery learning is a negative effect on the curve due to the removal of students that have already mastered the tested skill Mastery learning depresses performance increases in learning curves aggregated across student subpopulations, as the best performing students are removed from the aggregate population as they start performing well (when they master all skills for the section and move on to a different section or leave the tutor), at least for skills that are critical for graduating from the section, leaving only students who are performing less well.

### Mastery-Aligned Disaggregated Learning Curves

Aggregate learning curves as shown in FIG. 2 and FIG. 3 align users at first opportunity. An alternative, mastery-aligned learning curves, aligns students at the point of mastery. Referring to FIG. 4B, FIG. 4B depicts learning curves disaggregated according to an embodiment by the number of opportunities that it takes each subpopulation to reach skill mastery, aligned by the opportunity at which each subpopulation first achieves mastery. As with FIG. 4A, FIG. 4B also concerns the skill “Write composed linear function” and is also based on the same set of performance data. Each disaggregated curve still represents a set of students who have mastered the skill in a particular number of opportunities, as in FIG. 4A. However, in mastery-aligned learning curves, they are aligned at the point of first mastery. In FIG. 4B, m is the opportunity at which mastery was achieved, m−1 is the preceding opportunity, and so forth. The curve that is cut off for students who required 15 or more opportunities to reach mastery (some of whom may not reach mastery) simply show their first 14 opportunities.

Curves aligned by mastery make it easier to visualize whether different student subpopulations follow a similar path as they approach mastery, as would be the case if the students have similar rates of learning, corresponding to BKT parameter p_learn, but different initial knowledge, corresponding to BKT parameter p_initial. In these curves, student subpopulations' performance profiles may look similar as they approach mastery.

### Potential Impact

To investigate the frequency with which aggregate learning curves fail to show learning even when students appear to be learning at runtime, data on example Cognitive Tutor Algebra I curriculum was studied, for which performance data for 15,414 unique students on 881 skills was recorded.

Skills that are most likely to be better modeled by disaggregated learning curves are those that the tutor (at runtime) thinks most students are learning, but that don't show learning in their aggregate learning curves. Criteria was set such that a learning curve does not show learning if the fitted power function's exponent α is greater than −0.1—i.e., if the fitted power function is relatively flat or even decreasing in terms of percentage correct—and conversely, a learning curve does show learning for α≦−0.1. The results of applying the criteria to the performance data from the example Algebra I curriculum are shown in Table 1 below.

TABLE 1
Skills in Algebra 1

| | |
|---|---|
| All skills | 881 |
| Skills that are not premastered | 720 |
| Non-premastered skills with aggregate learning curves that don't | 375 |
| show learning | |
| Candidate skills for disaggregation: Tutor thinks students are | 166 |
| learning, not premastered don't show learning on aggregate curve, | |
| don't have multiple maxima, at least 250 students | |
| Candidate skills that show learning when disaggregated | 117 |

One reason that a skill may not show learning is that students already know it (performance on the learning curve starts out at or above 95%), so there is not much learning left to do—these are referred to as premastered. Another reason may be that knowledge that is modeled as a single skill may actually consist of more than one skill [3], or the skill may be poorly modeled in some other way. Learning curves for composite and poorly modeled skills often show fluctuating performance—i.e., multiple local maxima—as students alternate between practicing two or more distinct skills with different learning trajectories.

Therefore, skills were selected for disaggregation based on skills (1) the tutor thinks students are learning, operationalized as at least 75% of students achieve mastery within 12 opportunities; (2) do not show learning in the aggregate curve, as indicated by a fitted power function exponent of α>−0.1; (3) are not premastered; and (4) do not have multiple local maxima. In addition, (5) a skill was only selected if data was available for at least 250 students, both for stable statistical properties and to have enough data points to smooth out random fluctuations in the curves. As shown in Table 1, this process identified 166 skills (approximately 23% of skills that are not premastered) that were potentially misidentified by their aggregate learning curves as not showing learning.

For each of these 166 skills, disaggregated learning curves were created by grouping students into subpopulations according to the number of opportunities it took them to reach mastery, as assessed by the runtime BKT parameters. The power function fit for each of these curves was then computed. A skill was classified as showing learning if at least 75% of its students were represented by a disaggregated learning curve that showed learning. This had the effect of weighting the disaggregated curves so that, for instance, a learning curve representing 20 students would not count as much as a learning curve representing 200 students. Using these criteria, 117 of the 166 skills, or 70%, showed learning when their skills were disaggregated. Overall, at least 117 skills (those for which enough data was available) of 720 skills that students did not already know, or approximately 16%, had been misidentified as showing no learning. Accordingly, the use of disaggregated learning curves has the potential to correct significant non-learning misidentification errors that would result from using standard aggregated learning curves.

### Applications for the Disaggregated Learning Curves

Disaggregated learning curves can reconcile an apparent mismatch between the tutor's runtime assessment of student knowledge and the post hoc assessment provided by the aggregate learning curve. These representations have the potential to provide information to improve real-time student modeling and to more accurately depict educational effectiveness.

Although the disaggregated learning curves described here are calculated post hoc, they represent different underlying patterns of student learning. When a teacher or an educational software system identifies a particular student's membership in one of the underlying subpopulations, the trajectory of that student's learning is better predicted. A teacher or an educational software system can make a quick estimate of the student's likely path and then adapt accordingly, in a manner similar to that described in Pardos, Z. A., & Heffernan, N. T. (2010), Modeling individualization in a Bayesian networks implementation of knowledge tracing in Proceedings of the 18th International Conference on User Modeling, Adaptation and Personalization (pp. 255-266), which is incorporated herein by reference.

Another important application of disaggregated learning curves is to better distinguish effective vs. ineffective educational content or practices in automated tutoring models. For instance, the Cognitive Tutor includes curricula for thousands of skills; with such a large data set, efforts to improve the curricula must be prioritized. Accordingly, a series of attention metrics can be developed, which are heuristics for automatically examining data to identify elements of the Cognitive Tutors that deserve attention by developers. One of the attention metrics can assess whether students are learning the skills that they are expected to be learning. If aggregate learning curves are used to detect skills that students are not learning, a significant number of false positives are generated. Using disaggregated learning curves should provide more accurate metrics for whether students are learning particular skills. This information can be used to prioritize development efforts for a product that is more educationally effective overall.

### Evaluating Disaggregated Learning Curves for a Tutoring System

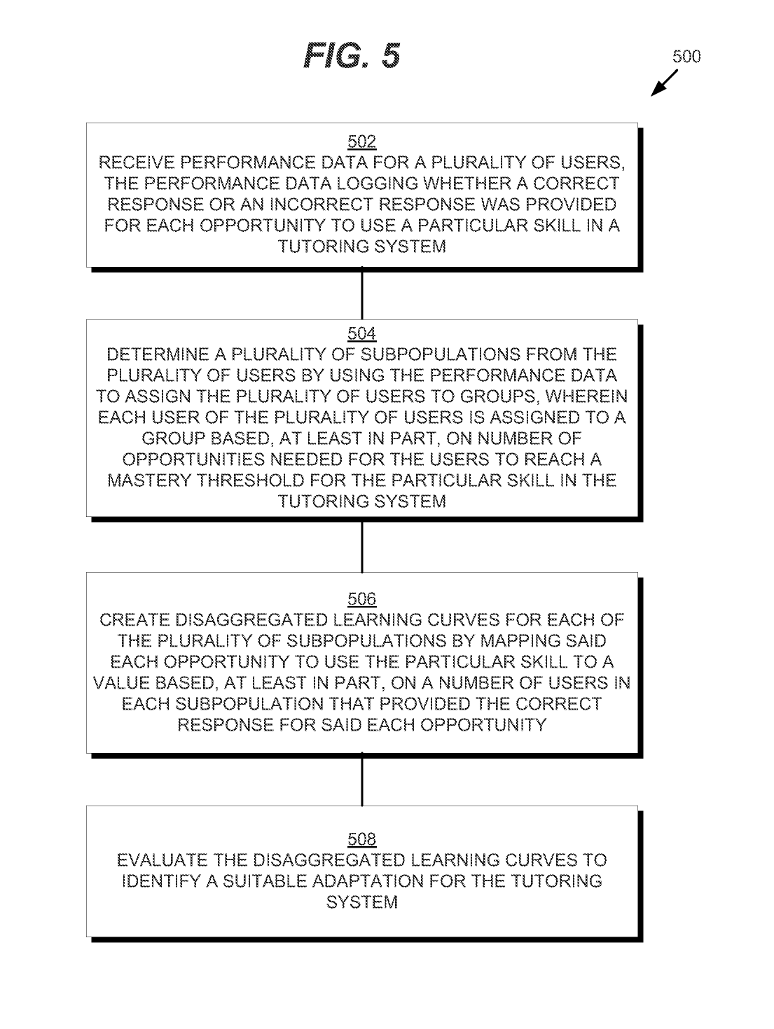

To provide a process-level overview of how the disaggregated learning curves can be utilized in a tutoring system, FIG. 5 depicts a flowchart 500 for providing a tutoring system that adapts by evaluating disaggregated learning curves by student mastery, according to an embodiment. At step 502 of flowchart 500, referring to FIG. 1, tutoring service 132 of server device 130 receives performance data 142 for a plurality of users. As shown in FIG. 1, this may be by querying a database such as database 140. For example, performance data 142 may log performance for all students of an Algebra I class. As discussed above, performance data 142 may have logged whether a correct response or an incorrect response was provided when each user encounters an opportunity to exercise a particular skill Note that a request for help, such as a hint request, may count as an incorrect response even if a correct answer is eventually provided. Continuing with the Algebra I example, the particular skill would correspond to one of the various skills that are tested in the Algebra I curriculum, which may be described in lesson data 146. Accordingly, the particular skill may for example correspond to the skill of writing a composed linear function, as illustrated in FIG. 3 and FIG. 4A.

Note that performance data 142 may include data for any desired time period and for any desired set of users. For example, performance data 142 may concern post-hoc data from a prior class or time period of Algebra I students in the past, allowing historical trends to inform the present tutoring models. In other embodiments, performance data 142 may log data from present users, exclusively or combined with past data. For example, performance data 142 may be populated in real-time as the users of client devices 110A-110C work through lessons in the tutoring system. In this case, tutoring service 132 may receive continuous updates of performance data 142, rather than a single static set of data. This approach may be preferred for new topics that do not yet have established historical performance data, or to provide flexibility to adapt to various different situations. Note that while performance data 142 may concern data for a large number of users over a long time period, in some embodiments only a representative sample of users and/or data points may be received from performance data 142 in step 502.

At step 504 of flowchart 500, referring to FIG. 1, tutoring service 132 of server device 130 determines a plurality of subpopulations from the plurality of users by using performance data 142 to assign the plurality of users to groups. These groups are assigned based, at least in part, on a number of opportunities needed for the user to reach a mastery threshold for the particular skill in the tutoring system. For example, it can be seen in FIG. 4A that several subpopulations are provided, including subpopulations needing 3, 4, 5, 6, 7, 8, 9, 11, 12, 13, 14, and 15+ opportunities before reaching mastery for the particular skill. As discussed above, skill mastery was defined by using a BKT p_known mastery threshold of 0.95 for each skill. However, any suitable mastery threshold may be utilized, and skill assessment may not necessarily utilize BKT.

Additionally, while a separate subpopulation is created for each represented number of opportunities in FIG. 4A, any suitable division of opportunity number ranges may also be utilized to create the subpopulations. For example, by observing historical data it may be ascertained that people generally fall into three general learning models for the particular skill. In this case, an alternative embodiment may provide three subpopulations for these learning models, such as a first subpopulation for users requiring no more than 6 opportunities to reach mastery, a second subpopulation for users requiring 7 to 10 opportunities to reach mastery, and a third subpopulation for users requiring 11 or more opportunities to reach mastery.

At step 506 of flowchart 500, referring to FIG. 1, tutoring service 132 of server device 130 creates disaggregated learning curves for each of the plurality of subpopulations by mapping said each opportunity to use the particular skill to a value based, at least in part, on a number of users in each subpopulation that provided the correct response for said each opportunity. In the example mappings shown in FIG. 4A, this value corresponds to the number of users in each subpopulation that provided the correct response for each opportunity divided by the number of users in each subpopulation, or a percentage of the subpopulation that provided a correct response for each opportunity. However, alternative values could also be used, for example by using curves that use the number of users providing incorrect responses instead, which can be readily derived from the number of users providing correct responses. The values for the mappings in these disaggregated learning curves can be readily determined by processing performance data 142 according to the subpopulations determined in step 504.

For example, referring to FIG. 4A, the mapping of the disaggregated learning curves are graphed with the x axis representing the nth opportunity for using the particular skill and the y axis representing the percentage of correct responses received for a given subpopulation. For the learning curve of the subpopulation requiring 3 opportunities before reaching mastery, 100% of the subpopulation, or all 56 users, answered correctly for opportunities #1, #2, and #3, for a perfect performance. For the learning curve of the subpopulation requiring 4 opportunities before reaching mastery, approximately 67% of the subpopulation, or 67% of 78 users, answered correctly for opportunity #1, approximately 64% of the subpopulation answered correctly for opportunity #2, approximately 70% of the subpopulation answered correctly for opportunity #3, and 100% of the subpopulation answered correctly for opportunity #4.

At step 508 of flowchart 500, referring to FIG. 1, tutoring service 132 of server device 130 evaluates the disaggregated learning curves to identify a suitable adaptation for the tutoring system. For example, as discussed above, each of the learning curves can be fitted to a power function to evaluate whether learning is occurring for the associated subpopulation. If the fitted power function meets a minimum exponent, then the associated subpopulation may be considered to be learning the particular skill. Otherwise, if the learning curve does not resemble a power function or if the exponent is too small, thus indicating a relatively flat curve, then the associated subpopulation may be considered to not be learning the particular skill Exceptions may be made for outliers such as premastered skills, which may be removed from consideration.

To provide an evaluation of whether learning is occurring for the user population as a whole, the number of users in the subpopulations considered to be learning may be added together and divided by the total number of users to determine a percentage of users that demonstrated learning of the particular skill. If this percentage meets a particular threshold, for example at least 75% as discussed above, then learning of the particular skill may be considered to be occurring for most of the population.

As discussed above, since developers and teachers may have limited resources available to implement lesson improvements and refinements, especially if lesson data 146 covers a large number of skills, then one or more attention metrics 148 may be developed to help prioritize resources to portions of the tutoring system that need the most attention. For example, the learning percentage may be weighed as part of an attention metric, and those skills that have a sufficiently low learning percentage, for example below 30%, may be flagged as portions that warrant greater attention.

Thus, once an evaluation of the disaggregated learning curves is carried out, tutoring service 132 of server device 130 may cause a suitable adaptation to be carried out for the tutoring system. One suitable adaptation may be to modify lesson data 146. In one embodiment, the modeling of the skill may be further refined, for example by dividing a composite skill into separate skills. In another embodiment, the presentation related to the skill may be further refined, for example by providing clarified instructions. In yet another embodiment, reference materials such as textbooks or course materials may be revised to improve the teaching of the skill, or to align the presentation of the course materials more consistently with the tutoring system. In still another embodiment, questions using the skill may be deferred for another tutoring session, providing time to implement different adaptations for the skill in the tutor.

Another suitable adaptation may be to send a notification concerning a particular skill that does not show learning, the notification identifying that the particular skill may warrant additional attention for refinement or refactoring. The notification may for example be sent over network 120 to one or more relevant persons such as developers, instructors, or other staff, for example by an e-mail message, instant message, text message, or other communication protocols.

Yet another suitable adaptation may be based on related skills or particular groups of skills in lesson data 146. For example, if a particular skill does not show learning according to the disaggregated learning curves, than a notification may be sent to identify that skills related to that particular skill may also possibly need further attention.

While the above adaptations concern improvements and notifications concerning the tutoring system itself, suitable adaptations may also be provided to better tailor the tutoring system for a particular user using tutoring service 132. For example, user profile data 144 may be maintained for each user associated with respective client devices 110A-110C. By default, the parameters of lesson data 146 may be uniform on a per-skill basis for all of the users using tutoring service 132. As each user provides additional data for performance data 142, each user can be more closely estimated to have a membership within a particular subpopulation of the plurality of subpopulations. By determining this membership for a particular user, a projected learning trajectory can be estimated for the particular user. Accordingly, the parameters for lesson data 146 can be adjusted in user profile data 144 based on the determined membership of the particular user to better suit his individual learning needs. Moreover, these adjustments can occur while a tutoring session is in progress for the particular user, allowing the tutoring session to be adjusted for the particular user in real-time.

Determining membership of a particular user within a particular subpopulation may also be assisted by using external data, for example demographic data. Additionally, the external data may be utilized to establish possible correlations of particular subpopulations to particular groups or demographics. This correlation data may then be utilized to help establish membership of future users within a particular subpopulation.

To provide an example parameter adjustment, if the particular user is determined to be a member of a subpopulation requiring only 3 or 4 opportunities before mastery of a particular skill, then the lesson speed may be increased and more difficult problems may be presented. Alternatively, development of other skills may be prioritized over the particular skill. On the other hand, if the user is determined to be a member of a subpopulation requiring 10 or more opportunities before mastery, then the lesson speed may be decreased and problems may be slowly introduced with a gradual difficulty progression. In this manner, the disaggregated learning curves can be used to estimate a learning progression for a particular user and to adjust the parameters of the tutoring system accordingly.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

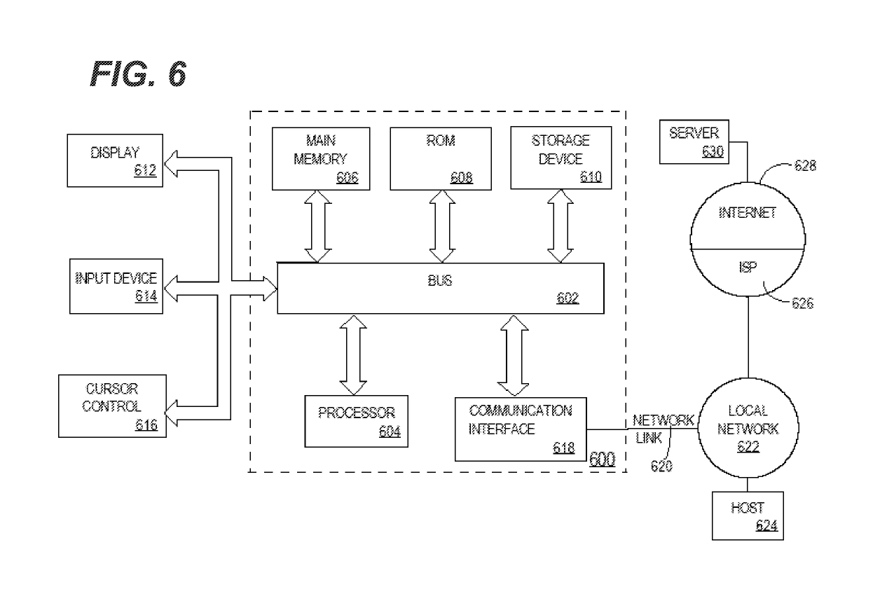

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving performance data for a plurality of users, the performance data logging whether a correct response or an incorrect response was provided for each opportunity to use a particular skill in a tutoring system;
determining a plurality of subpopulations from the plurality of users by using the performance data to assign the plurality of users to groups, wherein each user of the plurality of users is assigned to a group based, at least in part, on number of opportunities needed for the user to reach a mastery threshold for the particular skill in the tutoring system;
creating disaggregated learning curves for each of the plurality of subpopulations by mapping said each opportunity to use the particular skill to a value based, at least in part, on a number of users in each subpopulation that provided the correct response for said each opportunity;
evaluating the disaggregated learning curves to identify a suitable adaptation for the tutoring system;
wherein the method is performed by one or more computing devices.

2. The method of claim 1, wherein the method further comprises:
causing the suitable adaptation to be carried out.

3. The method of claim 1, wherein the evaluating determines whether each of the disaggregated learning curves fits a power function meeting a minimum exponent, the fitting demonstrating a learning of the particular skill by an associated subpopulation.

4. The method of claim 3, wherein the suitable adaptation comprises weighing an attention metric to identify a portion of the tutoring system for attention, wherein the attention metric is based on a percentage of the plurality of users that demonstrated the learning of the particular skill.

5. The method of claim 4, further comprising sending a notification concerning the portion of the tutoring system for attention.

6. The method of claim 1, wherein the evaluating determines a membership of a particular user within a particular subpopulation from the plurality of subpopulations.

7. The method of claim 6, wherein the suitable adaptation comprises adjusting the tutoring system for the particular user based on the determined membership of the particular user.

8. The method of claim 7, wherein the adjusting of the tutoring system is for an in-progress tutoring session.

9. The method of claim 1, wherein the determining of the plurality of subpopulations uses Bayesian Knowledge Tracing.

10. A tutoring system comprising one or more computing devices configured to:
receive performance data for a plurality of users, the performance data logging whether a correct response or an incorrect response was provided for each opportunity to use a particular skill in the tutoring system;
determine a plurality of subpopulations from the plurality of users by using the performance data to assign the plurality of users to groups, wherein each user of the plurality of users is assigned to a group based, at least in part, on number of opportunities needed for the user to reach a mastery threshold for the particular skill in the tutoring system;
create disaggregated learning curves for each of the plurality of subpopulations by mapping said each opportunity to use the particular skill to a value based, at least in part, on a number of users in each subpopulation that provided the correct response for said each opportunity;
evaluate the disaggregated learning curves to identify a suitable adaptation for the tutoring system.

11. The tutoring system of claim 10, wherein the tutoring system is configured to evaluate by determining whether each of the disaggregated learning curves fits a power function meeting a minimum exponent, the fitting demonstrating a learning of the particular skill by an associated subpopulation.

12. The tutoring system of claim 11, wherein the suitable adaptation comprises calculating an attention metric using a population percentage to identify a portion of the tutoring system for attention, wherein the population percentage corresponds to a percentage of the plurality of users that demonstrated the learning of the particular skill.

13. The tutoring system of claim 11, wherein the tutoring system is configured to evaluate by determining a membership of a particular user within a particular subpopulation from the plurality of subpopulations, and wherein the suitable adaptation comprises adjusting the tutoring system for the particular user based on the determined membership of the particular user.

14. A non-transitory computer-readable medium storing one or more sequences of instructions which, when executed by one or more processors, cause performing of:
receiving performance data for a plurality of users, the performance data logging whether a correct response or an incorrect response was provided for each opportunity to use a particular skill in a tutoring system;
determining a plurality of subpopulations from the plurality of users by using the performance data to assign the plurality of users to groups, wherein each user of the plurality of users is assigned to a group based, at least in part, on number of opportunities needed for the user to reach a mastery threshold for the particular skill in the tutoring system;
creating disaggregated learning curves for each of the plurality of subpopulations by mapping said each opportunity to use the particular skill to a value based, at least in part, on a number of users in each subpopulation that provided the correct response for said each opportunity;
evaluating the disaggregated learning curves to identify a suitable adaptation for the tutoring system.

15. The non-transitory computer-readable medium of claim 14, wherein the one or more sequences of instructions further cause performing of:
causing the suitable adaptation to be carried out.

16. The non-transitory computer-readable medium of claim 14, wherein the evaluating determines whether each of the disaggregated learning curves fits a power function meeting a minimum exponent, the fitting demonstrating a learning of the particular skill by an associated subpopulation.

17. The non-transitory computer-readable medium of claim 16, wherein the suitable adaptation comprises weighing an attention metric to identify a portion of the tutoring system for attention, wherein the attention metric is based on a percentage of the plurality of users that demonstrated the learning of the particular skill.

18. The non-transitory computer-readable medium of claim 17, wherein the one or more sequences of instructions further cause:
sending a notification concerning the portion of the tutoring system for attention.

19. The non-transitory computer-readable medium of claim 14, wherein the evaluating determines a membership of a particular user within a particular subpopulation from the plurality of subpopulations.

20. The non-transitory computer-readable medium of claim 19, wherein the suitable adaptation comprises adjusting the tutoring system for the particular user based on the determined membership of the particular user.
